(19) United States
(12) Patent Application Publication
(10) Pub. No.: US 2019/0385597 A1
(43) Pub. Date: Dec. 19, 2019

(54) DEEP ACTIONABLE BEHAVIORAL PROFILING AND SHAPING

(71) Applicant: Behavioral Signal Technologies, Inc., Los Angeles, CA (US)

(72) Inventors: Athanasios Katsamanis, Keratsini (GR); Shrikanth Narayanan, Santa Monica, CA (US); Alexandros Potamianos, Santa Monica, CA (US)

(21) Appl. No.: 16/441,521

(22) Filed: Jun. 14, 2019

Related U.S. Application Data
(60) Provisional application No. 62/684,934, filed on Jun. 14, 2018.

(51) Int. Cl. G10L 15/18; G10L 15/22; G06F 17/27; G06K 9/62; G06N 20/00; G06N 3/04

(52) U.S. Cl. CPC G10L 15/1815; G10L 15/22; G06F 17/2705; G10L 2015/227; G06N 20/00; G06N 3/04; G06K 9/6256

(57) ABSTRACT

Behavioral profiling and shaping is used in a “closed-loop” in that an interaction with at least one human is monitored and based on inferred characteristics of the interaction with that human (e.g., their behavioral profile) the interaction is guided. In one exemplary embodiment, the interaction is between two humans, for example, a “customer” and an “agent” and the interaction is monitored and the agent is guided according to the inferred behavioral profile of the customer (or optionally of the agent themselves).

### CROSS-REFERENCE TO RELATED APPLICATIONS

This application claims the benefit of U.S. Provisional Application No. 62/684,934, filed on Jun. 14, 2018, which is incorporated herein by reference.

### BACKGROUND

This application relates to behavioral profiling and shaping, and more particularly to providing an aid in a multiparty interaction using such profiling and shaping.

Understanding, supporting and influencing behaviors is a core element of many human encounters. Consider for example the broad domain of customer service; the agent—whether human or computer-implemented (e.g., autonomous)—attempts to understand the need of the customer and provides the appropriate service such as to help solve a problem, or to initiate and complete a business transaction e.g., new purchase. Similar human contact encounters abound in business scenarios whether in commerce (e.g., contact centers, front desk reception), health (e.g., patient-provider interactions), security (e.g., crime interviews) or the media (e.g., news gathering). A common theme of these encounters, even if they are transactional, is that they may go well beyond the transactional elements of gathering explicit expressed needs and servicing those: they may rely on the implicit and subtly expressed and experienced behavioral elements of the interacting agents in the processing of the encounter. Given the vast heterogeneity, variability and uncertainty in human behavioral expressions, the context in which the encounter happens, and the associated cognitive and mental traits and abilities of the agents to “read” and “respond” to the unfolding expressed/experienced behaviors, there is no perfect or clearly defined formula or recipe for achieving the desired outcomes of the encounter. Example outcomes vary by application: in a sales encounter it is product purchase, in a collection scenario it is getting bills paid, in a teaching encounter it is getting better test scores, in a clinical situation it is mitigating the health/behavioral issue at hand.

Identifying the optimal agent behavioral profiles/patterns is certainly a long standing issue in the contact center industry. For instance, consider a contact center encounter in the collections industry where agents, in their communication with debtors, need to balance and find a sweet spot between possibly competing behavioral expressions (agitation vs. empathy) to achieve their goal, e.g., receive a reliable promise to pay. This needs to happen in alignment with the traits and state of the customer as conveyed through the customer's behavioral expressions, and any additional background information about them that may or may not be available. So, the agent is required to process their interlocutor's behavior, and choose and express their own behavioral response action that is in tune with both the interaction context and the transactional goals. More successful agents appear to behave more appropriately and it is the responsibility of the quality assurance (QA) team, experienced supervisors or of the call center manager to identify related competencies and try to train the agents to behave/act in similar ways. For example, some desired competencies include agent politeness, compliments, agent ownership and empathy. While transactional goals can be codified, and certain desired agent behavioral response patterns can be targeted (and trained for), the variety and uncertainty in both the behavioral expressions from the customer and the ability of the agent to process and respond to those expressed behaviors makes it challenging, if not impossible to implement the optimal behavioral expression-response complex.

### SUMMARY

In one aspect, in general, approaches described below implement behavioral profiling and shaping. In at least some embodiments, the approach is “closed-loop” in that an interaction with at least one human is monitored and based on inferred characteristics of the interaction with that human (e.g., their behavioral profile) the interaction is guided. In one exemplary embodiment, the interaction is between two humans, for example, a “customer” and an “agent” and the interaction is monitored and the agent is guided according to the inferred behavioral profile of the customer (or optionally of the agent themselves). In at least some embodiments, this guiding of the interaction is in the form of feedback to the agent to suggest topics or other nature of interaction with the customer, and this feedback is formed with a particular goal, for example, attempting to have the interaction result in a desirable outcome (e.g., customer satisfaction, sales results, etc.). The monitoring of the subject generally involves human speech and language analytics, emotion analytics from verbal and nonverbal behavior, and interaction analytics. As an interaction progresses, the monitoring can yield quantification of behaviors as they are occurring in the interaction, and feedback to the agent may be based on such a quantification.

In another aspect, in general, a method is directed to aiding a multi-party interaction. The method includes acquiring signals corresponding to successive communication events between multiple (e.g., two) parties, and processing the signals to generate a plurality of profile indicators. The profile indicators are processed to generate a recommendation for presenting to at least one of the parties in the interaction, and that recommendation is presented to at least one of the parties.

Aspects can include one or more of the following.

The successive communication events comprise conversational turns in a dialog between the multiple parties.

The successive communication events comprise separate dialogs (e.g., separate telephone calls) between the multiple parties.

The successive communication events comprise linguistic communication events comprising spoken or textual communication.

Processing the signals to generate the plurality of profile indicators includes performing automated speech recognition of the signals.

Processing the signals to generate the plurality of profile indicators includes performing a direct conversion of a speech signal without explicit recognition of words spoken.

Processing the signals to generate the plurality of profile indicators includes semantic analysis of linguistic content of the signals.

The signals corresponding to successive communication events represent non-verbal behavioral features.

Processing the signals generate the profile indicators comprises processing the signals using a first machine-learning component to generate the profile indicators.

Processing the profile indicators to generate a recommendation comprises processing the profile indicators using a second machine-learning component.

The generating of the recommendation is ongoing during an interaction based on events in the interaction that have occurred.

The recommendation includes an indicator related to success of a goal for the interaction.

In another aspect, software stored on a non-transitory machine-readable medium includes instructions for causing a data processing system to perform all the steps of any of the methods set forth above.

In another aspect, a system is configured to perform all the steps of any of the methods set forth above.

In another aspect, in general, a method is directed to aiding a multi-party interaction. The method includes acquiring signals corresponding to successive communication events between multiple (e.g., pairs of) parties, and processing the signals to generate a plurality of profile indicators. The profile indicators are processed to determine a match between parties (e.g., a match between customers and agents). The match between parties is used to route a further communication event (e.g., a telephone call) involving at least one of the parties.

It should be understood that although a result that may be achieved is to provide feedback to an agent so that they may react in the manner of a trained (e.g., empathetic) human, the approach is not a mere automation of the manner in which humans interact. At very least, humans interacting with one another do not form quantifications of behavior characteristics which then guide their interactions. Therefore in a like manner that a human may be technologically augmented, for example, with an artificial limb or a powered exoskeleton, approaches described herein provide a technological way of augmenting a human's ability to interact with a subject to achieve a desired outcome.

It should also be recognized that feedback to a human agent is only one example of the use of the technological approaches described below. For instance, the same approaches to profiling and shaping may be applied in control of an interaction with a computer-implemented agent.

### DESCRIPTION OF DRAWINGS

FIG. 1 is is a block diagram illustrating an interaction between speakers.

FIG. 2 is is a timeline illustration of an interaction between speakers.

FIG. 3 is is a block diagram of a recommender.

FIG. 4 is a block diagram illustrating runtime processing.

FIG. 5 is a block diagram illustrating training of behavioral feature extractors.

FIG. 6 is a block diagram illustrating training of a behavioral response generator.

### DETAILED DESCRIPTION

### Overview

Referring to FIG. 1 a runtime system 100 supports a human-human interaction, which in this example is a spoken interaction between a speaker A 101 and a speaker B 102. More specifically in this use case, speaker A 101 is a customer and speaker B 102 is a call-center agent, and the speakers are communicating via corresponding communication devices (e.g., telephones, computers) 111, 112 over a communication link 103 (e.g., a telephone line, computer network connection). As will be evident below, it is not essential that the interaction be spoken, or that the roles of the interacting parties be “customer” and “agent.” For example, the interaction may be in the form of text (e.g., email or text messages), and in some examples, one (or both) of the parties are non-human computer-implemented agents.

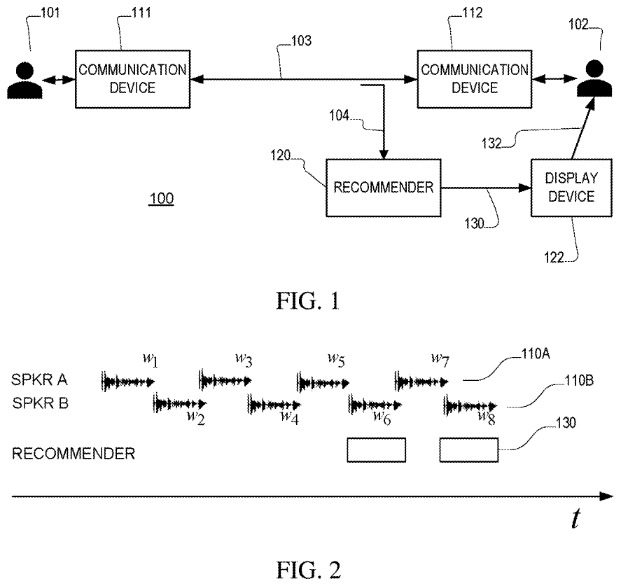

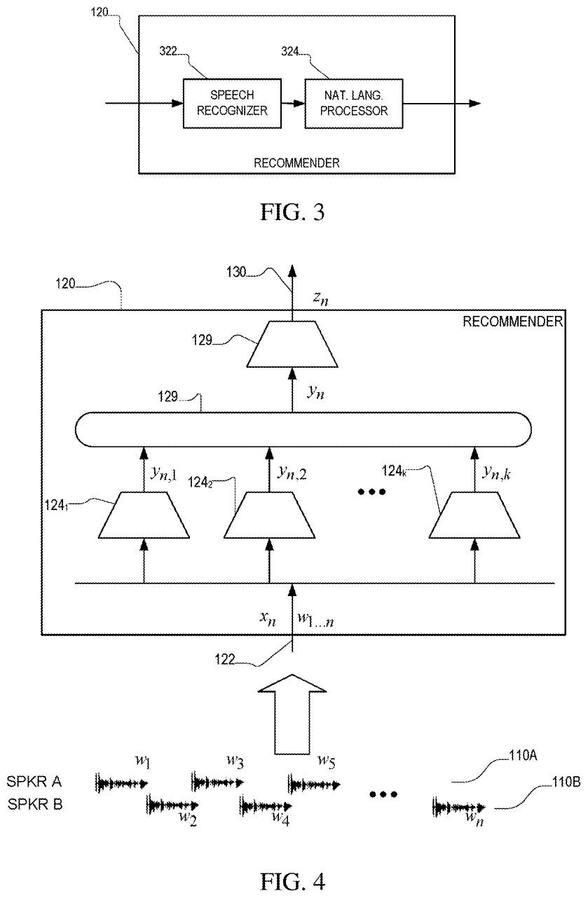

In this example shown in FIG. 1, speaker B (the agent) has a computer terminal 122 or other form of display or output device (e.g., an audio earphone device) that receives recommendation information 130 from a recommender 120 and presents it to the speaker. The recommender 120 is computer-implemented device or process that generally monitors the interaction (e.g., acquires a monitored signal 104) between the parties 101, 102 over the communication link 103, and generates the recommendation information 130 for presentation to one of the parties (here the agent 102) via a disclose device 122 (e.g., a computer screen). Referring to FIG. 2, the recommender monitors the signal 104, which includes the conversational turns between the parties, including utterances 110A by speaker A (labeled w₁, w₃, etc. in the Figure) and utterances 110B by speaker B (labeled w₂, w₄, etc. in the Figure), and produces outputs 130, for example, after each utterance by speaker A (or alternatively on an ongoing basis based on utterances by both parties). Referring to FIG. 3, an implementation of the recommender 120 makes use of a speech recognizer 322, which processes audio input and produces linguistic output, for example, in the form of a word sequence, and this output is passed to a natural language processor 324 which produces the output of the recommender.

As a first more specific example, a call-center agent is presented with recommendations during a call with a debtor regarding how she should be handling specific situation. The call is being processed in a streaming fashion and fully analyzed by the system 100. These recommendations appear as notifications on the screen of the agent. For example, in collections, the agent may get a warning that a particular call is not going to lead to a promise-to-pay by the debtor (or some other specific desired goal) and the agent may be advised to become more agitated or more empathetic.

In another example a sales agent may get a notification that the call is potentially not leading to a sale and that the agent may need to become more accommodating to the customer's requests.

In another type of use case, a sales representative, before following up with a particular prospective customer, can check the recommender's suggestion based on all previous voice or text communications with the customer. The suggestion may be expressed in natural language: “This customer is particularly aggressive. You may need to be more empathetic with him”.

In yet another use case an addiction therapist is reviewing all her previous interactions with a particular client and the system can specifically recommend that she should be following a specific therapy pattern in the following session or a particular style of interaction e.g., indicate that the client responds well to more humorous style.

A common aspect of some or all of these use cases is that the system generates and/or provides an automatically derived behavioral profile of a subject or of interactions between particular subjects, and this profile is used to guide further interaction. Although a skilled and experienced agent may be able to infer the information determined by the automated recommender, the machine-implemented recommender provides a technological solution, which essentially augments a user's perception skills and interaction experience. In this sense, the system does not merely automate what an agent would do manually or in their head, and rather provides information that enhances a user's ability to interact with a subject and accomplish goals of such an interaction.

Referring to FIG. 4, an embodiment of the system 100 is used to process successive “turns” 110A-B in a two-person spoken interaction between a speaker A and a speaker B. In the Figure, the turns are represented as a succession of items w₁, w₂, etc. with time flowing from top to bottom on the left of the figure. For example, the items wᵢ represent waveforms captured during each of the turns. As an exemplary use case, the interaction is a telephone interaction in which speaker A is a call center agent, and speaker B is a customer calling the call center. Items wᵢ can potentially also correspond to sequences of small “turns” during which there is no particular behavioral change exhibited from either the customer or the agent.

During the interaction, a recommender 120 processes successive input items, for example, w₁, . . . , wₙ representing the first n turns in the interaction (this sequence is represented by the symbol xₙ in the figure). Using the information in those first n turns, the recommender 120 computes a profile zₙ which may be used to determine a presentation (e.g., a recommendation) presented to the agent as a guide regarding how to further conduct the interaction in order to optimize the outcome.

In the call center context, the recommendation may include interaction recommendations such as a directive regarding the agent's behavior (e.g., a directive to calm down if the agent appears agitated) or a directive to guide the interaction in a particular direction (e.g., to attempt to sell a particular service, or to attempt to close a deal that was offered to the customer).

Structurally, the recommender 120 includes components associated with two sequential processing phases. In a first phase the representation xₙ of the turns to that point is first processed to yield a representation yₙ 127. This representation includes components that represent behavioral profile values for the agent and/or the customer. In general, this representation may include other components that represent semantic information in the input, for example, the words spoken, inferred topics being discussed etc. In the figure, this processing is illustrated using K feature extractors 124₁-124_{K}, producing respective outputs y_{n,1} through y_{n,K}, which are combined (e.g., concatenated) to form yₙ. In at least some embodiments, the feature extractors are implemented using Machine Learning (ML) techniques, for example, using (e.g., recurrent) neural networks that accept time signal samples derived from speech signals (e.g., waveform samples, signal processed features, etc.).

In the second phase of processing, a recommender 129 processes the representation yₙ 127 to produce the recommendation zₙ 130. It also provides an indication whether this particular representation is on track or not with respect to achieving the desired outcome. In some embodiments, the recommendation is a subset of a predetermined set of categorical recommendations. In at least some embodiments, the recommender is also implemented using ML techniques, for example, using a neural network with one (or a pair) of outputs for each possible categorical recommendation.

Training of the feature extractors makes use of a training corpus of multiple interactions, the m^{th} interaction including a sequence of turns, and each overall interaction being annotated with a utility or quality of the interaction (e.g., a quantity ũₘ for the m^{th} interaction). Furthermore each turn, with a signal wᵢ is annotated with features \tilde{y}_{i,1} to \tilde{y}_{i,K}, at least some of which are behavioral features.

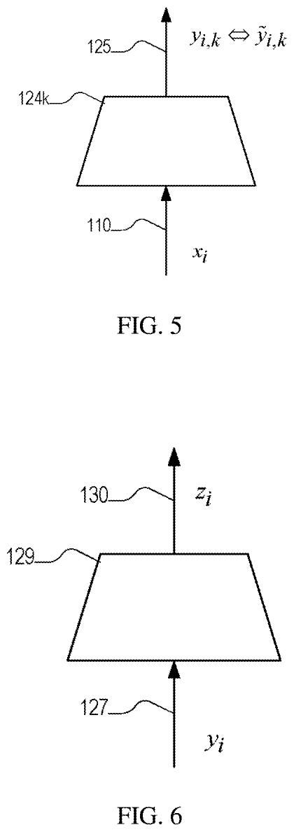

Referring to FIG. 5, each feature extractor 124ₖ is configured by corresponding parameters θₖ. In training, these parameters are selected such that for an input xᵢ the output of the feature extractor, y_{i,k} matches the annotated \tilde{y}_{i,k} in an average sense according to a chosen loss function over the training corpus.

Referring to FIG. 6, having trained the feature extractors, the inputs wᵢ are processed to create a training corpus of paired features yᵢ and corresponding recommendations \tilde{z}ᵢ.

Training of the recommender 120 makes use of a training corpus of multiple interactions, i.e., sequences of wᵢ, and each overall interaction being labeled by the corresponding high-level/utility outcome ũₘ, e.g., whether it has led to a sale or not. The corpus may or may not be the same as the one described above and used for training the feature extractors. Using the corpus, a separate recommender 120 is trained for each desired outcome. More specifically, the inputs wᵢ of all interactions leading to this outcome are first processed by the feature extractors described above and each is subsequently represented by a vector Yᵢ which includes behavioral profile values for the agent or the customer (y_{i,1} . . . y_{i,K} values for turn wᵢ). As a result of this process, each interaction is represented as a sequence of these vectors Y₁, . . . , Yᵢ₋₁, Yᵢ, Yᵢ₊₁, . . . . A multi-label sequence classifier is then trained to predict a discretized version of Yₘ based on the sequence of Y₁ up to Yₘ₋₁. This prediction is the system's recommendation zₘ 130 in runtime (based on all the speaker turns up to Wₘ). In some embodiments, this classifier is implemented as a version of a multi-label (given that Yᵢ is essentially multidimensional) (recurrent) neural network. For getting the discretized representation Y′ₘ from Yₘ continuous feature values are replaced by corresponding categorical values based on thresholding, e.g., high/mid/low.

In a similar fashion, the recommender can be trained on sequences of interactions when each of them is represented by an interaction-level behavioral profile. This profile is estimated based on interaction-level feature extractors.

One additional element of the recommender's output is an indication whether the call is on track or not with respect to the desired outcome. This is the output of a separate classifier trained on (sub)sequences of Yᵢ but this time to estimate the interaction-level label based on the current evidence each time. The same training corpus used in this case but this time all interactions (leading to all alternative utility outcome values) are used. In at least some embodiments this classifier is also implemented using ML techniques, for example, using a (recurrent) neural network.

Although described in the context of human-human interaction, the approaches described above may be applied to human-machine interaction, for example, with a machine-implemented agent. In such an alternative, the recommendation output may be used as an input to guide automated dialog to react to a behavioral profile of the caller in order to achieve a desired goal (e.g., satisfaction, sale conversion, etc.).

Examples of the system may include a number of features introduced above or used in conjunction with the aspects described above. A number of these features relate to the direct end-to-end mapping of behavioral signal expressions to behavioral signal responses, which use linear or nonlinear mathematical mapping functions to map directly behavioral expressions to behavioral actions. This includes using sequence-to-sequence models of signal expressions to signal responses. The approach may use neural network structures and architectures, including deep networks to derive mapping functions. Alternatively, the approach may use heuristic rules to derive mapping functions. The approach may also use other optimization functions to derive mapping functions e.g., optimization can target rapid call completion in a telephone contact center application, or game theory to derive mapping functions. In some examples, human training is used to derive mapping functions. A hybrid arrangement of a combination of these techniques may also be used.

The system may generate a mapping of behavioral expressions to intermediate behavioral representations, such as semantic categories or groups of categories e.g., agitation, empathy, numerical representations e.g., word embeddings, or sequence of behavioral events or high-level behavioral labels. The system may decompose behavioral representations into semantic category (what is expressed) and modulation function (how something is expressed). The system may create a behavioral analysis by synthesis function of behavioral expression-response tuple. Such an analysis and synthesis can be implemented by autonomous machine processing, by human processing, or by combinations of autonomous machine processing and human processing. The system may score a behavioral expression-response mapping function based on external variables or functions of variables. In some examples, the system assigns numerical scoring functions to behavior expression-response tuples based on outcomes (categorical or numerical) e.g., successful completion of a payment, resolution of a problem, quality ratings, cure of a health condition (for patient provider interaction), or performance in a test (for teacher-student interaction). Scoring can be specified by ranking of the behavior expression-response tuples, or can be specified by clustering of behavior expression-response tuples. Scoring of behavioral expression-response mapping functions may be based on socio-cultural and demographic dimensions. For example, numerical scoring functions may be assigned to behavior expression-response tuples based on categorical or numerical ratings, scoring can be specified by ranking of the behavior expression-response tuples, or scoring can be specified by clustering of behavior expression-response tuples. Such scoring schemes can be combined with analysis by synthesis models of behavioral expression-response tuples.

In examples of the system, raw vocal audio signals are used to specify behavioral expressions. The system may use representations derived from vocal audio signals to specify behavioral expressions. A hybrid of raw and derived representations from vocal audio may be used to specify behavioral expressions. Language use patterns may be used to specify behavioral expressions. Linguistic representations derived from language patterns may be used to specify behavioral expressions. Numerical representations derived from language may be used to specify behavioral expressions. A hybrid of raw audio, audio derived representations, language use or derived linguistic representations may be used to specify behavioral expressions. Nonverbal markers (e.g., laughter, sighs etc) may be used to specify behavioral expressions. A hybrid of audio, language and nonverbal markers may be used to specify behavioral expressions. Video signals may be used to specify behavioral expressions. Semantic representations derived from video may be used to specify behavioral expressions. Numerical representations derived from video may be used to specify behavioral expressions.

Some examples of the system may use signals of physical activity, physiology, neural and brain functions to specify behavioral expressions. Semantic representations derived from aforementioned signals may be used to specify behavioral expressions. Numerical representations derived from aforementioned signals may be used to specify behavioral expressions. A hybrid of audio, video, physical activity, physiology or neural signal or signal representations may be used to specify behavioral representations.

### Processing Pipeline

In an exemplary embodiment, training and runtime components are implemented as described in this section.

During a training phase, audio recordings of human-human or human-machine interactions are used. In some cases, these recordings are not stereo (i.e., speakers are not recorded on separate channels) and a speaker diarization step is applied to separate the customer and agent segments of the recording. This diarization involves first locating speech segments (e.g., using a speech activity detector), splitting the audio segments into two groups, one for each speaker, and then assigning each group to either the agent role or the customer role, for example, using a linguistically-based assignment step (e.g., based on the words spoken). In some cases, each speaker is on a separate channel (as it happens often in telephone interactions) and then speech activity detection is applied to separate incoming speech into speaker turns. In some such cases, the role assignment is known (e.g., channel 1 is the agent and channel 2 is the customer), or if necessary the two channels are assigned roles as in the diarization case. After segmentation into turns for the agent and the customer, machine-implemented speech-to-text (speech recognition) is employed to get corresponding transcriptions of each of the turns. Therefore each conversation is a sequence of turns, each turn is assigned to either the customer or the agent, and the word sequence spoken in each turn is know, as are low-level descriptor (LLD) of the audio signals for each segment (e.g., frame energy, zero-crossing rate, pitch, probability of voicing, etc.).

Then, turn-based features are extracted for each turn using classifiers such as the ones described in Tzinis, Efthymios, and Alexandras Potamianos, “Segment-based speech emotion recognition using recurrent neural networks,” In 2017 Seventh International Conference on Affective Computing and Intelligent Interaction (ACII), pp. 190-195. IEEE, 2017, which is incorporated herein by reference. In particular, the LLD's may be processed by a recurrent neural networks, such as a Long Short-Term Memory (LSTM) neural network structure. The features that are extracted more specifically include one or more of:
Emotions, e.g., anger, happiness, excitement, sadness, frustration, neutrality, confidence, positiveness
Behaviors, e.g., aggressiveness, engagement, politeness, empathy
Intermediate-level features, e.g., speaking rate, vocal variety
Statistics of the above (average, variance, etc.)
Intent extracted using Machine-Learning (ML) Natural Language (NL) understanding (note that intents may be domain-specific, e.g., for collections, introductions, identity verification, payment refusal)

In addition, turn-based features may also be extracted in a multi-task multi-label way as presented in Gibson, James, and Shrikanth Narayanan, “Multi-label Multi-task Deep Learning for Behavioral Coding,” arXiv preprint arXiv:1810.12349 (2018), which is incorporated herein by reference.

A behavioral profile representation (a feature vector, which could also be seen as a behavioral embedding) is then formed for each speaker turn, based on available features. Pairs of behavioral profiles (one for each interacting speaker) are extracted for all pairs of consecutive speaker turns. The final outcome of the interaction is introduced as an additional feature to this representation (e.g., 0 for low propensity to pay, 1 for medium propensity to pay, 2 for high propensity to pay). The sequences of behavioral profile pairs are then used to train a sequence-to-sequence model (e.g., an RNN encoder-decoder architecture with attention mechanism, e.g., as shown in Luong, Minh-Thang, Hieu Pham, and Christopher D. Manning, “Effective approaches to attention-based neural machine translation,” arXiv preprint arXiv:1508.04025 (2015), which is incorporated herein by reference). From each sequence, multiple training samples are generated by splitting the sequence into two at various points/lengths (e.g., 1, 2, 3, . . . , N−1), with the subsequence preceding the splitting point being provided as the input, and the succeeding subsequence being considered to be the output.

In this way, the trained model can generate online the most probable sequence of behavioral profile pairs which follows a certain sequence of behavioral event pairs as it has been observed so far. The first element (behavioral profile pair) of that generated sequence, and more specifically the part of that which corresponds to the user of the system, e.g., the agent, is the recommendation provided to them at each instance. One option is that sequences which are non-discriminative among different interaction outcomes may be penalized during training.

In operation of the runtime component of the system, each speaker is expected to be recorded in a separate channel, or alternatively, on-line speaker diarization is performed as single-channel audio is acquired. In a call center embodiment, the recommendation to the agent is provided in the form of a discreet notification on the agent's screen but, in the general case, the notification could alternatively be provided in the form of a sensory stimulus (e.g., a vibration pattern indicating that the speaker should behave in a certain way). Speech recognition is optional at runtime, but if it is performed during the interaction, the semantic part of the behavioral profile is available in making the recommendations.

### Use Cases

A number of exemplary use cases of the approaches described above are provided in this section.

### Sales Enablement

In a first use case, a goal is to engage a customer (e.g., a potential customer who has been “cold called” by the agent). Today, outbound marketing (e.g., online sales) calls result in hangup (e.g., the call does not result in greater than 30 seconds duration) over 70% of the time. The goal in this use case is to track the behavioral profile of the customer and recommend to the agent placing the call how best to avoid “immediate refusal” or hangup “Immediate refusal” is when the customer refuses to continue the conversation right after the presentation of the “product” is made, approximately 60-80 seconds into the call. Reduction of this percentage is strongly correlated with increase in sales. Empirically, different agents, and different contexts (e.g., time of day, the nature of the campaign etc.) result in an immediate refusal rate ranging from 55% to 85%.

In this use case, the agent receives recommendations, which may include one or more of:
Slow down
Try being more expressive
Stress the vowels more/Enunciate better
The customer sounds less engaged
“Things are looking good” vs. “Customer appears to be disengaged”

For example, the recommendations are presented via the agent's softphone or a desktop application while the agent is interacting with the customer. In an experimental evaluation of this approach, agents receiving the recommendations had a first refusal rate that was 8 percentage points lower than agents not receiving the recommendations. In a variant or optional feature of this use case, results for customer experience score are aggregated at the agent (or agent-team) level.

### Improving Collections

Another use case also involves outbound calling by an agent to a customer, but in this use case the goal is to improve collection on a debt. For example, one measure of success is based on whether the agent receives a “promise to pay” from the customer, which has a correlation with actual future payment by the customer. However, not all such promises are equal, and there is further value in being able to evaluate whether a customer's promise to pay is real or not. For example, a real promise to pay may not require a followup call by the agent as the agreed payment date approaches, while if the promise is not real, then further followup calls may be more warranted.

As compared to the previous use case presented above, this use case provides recommendations at the call level. That is, rather than processing each turn and providing a recommendation after each turn, each conversation (e.g., call) is treated as one sample in the sequence, and the goal is to optimize the future interaction with the customer to yield a true payment.

As an example, in one particular portfolio of calls, 20% of the calls result in refusal to pay for reasons such as income loss, etc. Of the calls, 14% of calls lead to promised to pay, and 40-45% of those promises are actually kept with the definition of a kept promise being that the required payment followed within seven days. In an example protocol without further behavioral interaction analysis, after a promise to pay has been received, the agent will call again after three days to confirm, and again the day before the payment is promised. Depending on how long into the future the promise is made, the customer may receive, 0, 1 or 2 followup calls. Note that knowing whether a promise is real can reduce these followup calls if they are not necessary, and potentially increase the number of the calls or push for payment more aggressively in calls or have a more skilled agent handle subsequent calls if the promise is deemed not to be real. Using the behavioral profiling, after each call, a post-call prediction is made whether the customer is actually going to pay. For example, this prediction may be quantized into “low,” “medium,” or “high.” This prediction is then used to determine when then next call is to be made (or if the call may be omitted), and possibly the type of agent that will handle the call. In general, goals of the system are to improve the calling strategy based on predictions, for example, reducing unnecessary calls to customers, improving the customer experience, and/or avoiding damage to the company's reputation, reduction of complaints and lawsuits. Furthermore, the goal is to actually increase the total collection of outstanding debt using the recommendation approach.

In an experimental evaluation of this use case, agents employing this recommendation approach were able to receive debt payments 7% higher than a comparable group of agents not using the recommendation approach.

### Agent-Customer Matching

In another use case, the goal is to match an inbound customer calls with particular agents or groups of agents that are expected to handle the interaction that customer. This recommendation is based on call-level profiling that is performed offline using past calls with the customer. For example, the recommendation causes call delivery based on the recommendation in an automatic call distribution (ACD) system.

In this use case, a successful call is based on completion of the transaction the customer is calling about, or potentially up-selling the customer. On the other hand, an unsuccessful call is one that doesn't result in the transaction or results in the customer complaining about the agent.

The match of the customer and an agent is based on the identification of patterns of behaviors and emotions exhibited by the agents, for example, how the agents react to the case of an angry customer, as well as an identification of the behavioral profile of each customer based on previous calls. Using the profiles, the system generates on ordered list of agents according to their likelihood of having a successful call with the customer. In some examples, the known customers are partitioned among groups of agents to best maximize successful calls. When a call comes into the ACD, the call is preferentially distributed to an agent in the matching group. For new callers, their calls are distributed using a conventional routing approach, such as to the agent with the longest idle time.

### Implementations and Alternatives

Implementations of the system may be realized in software, with instructions stored on a computer-readable medium for execution by a data processing system. The data processing system has access to the communication between the parties, for example, by being coupled to the communication system over which the parties communicate. In some examples, the data processing system is part of the computing and communication infrastructure supporting one of the parties, for example being part of a call center infrastructure supporting an agent.

These and other embodiments are within the scope of the appended claims.

What is claimed is:

1. A method for aiding a multi-party interaction comprising:
acquiring signals corresponding to successive communication events between multiple parties;
processing the signals to generate a plurality of profile indicators;
processing the profile indicators to generate a recommendation for presenting to at least one of the parties in the interaction; and
presenting the recommendation to the at least one of the parties.

2. The method of claim 1 wherein the successive communication events comprise conversational turns in a dialog between the multiple parties.

3. The method of claim 1 wherein the successive communication events comprise separate dialogs between the multiple parties.

4. The method of claim 1 wherein the successive communication events comprise linguistic communication events comprising spoken or textual communication.

5. The method of claim 4 wherein processing the signals to generate the plurality of profile indicators includes performing automated speech recognition of the signals.

6. The method of claim 4 wherein processing the signals to generate the plurality of profile indicators includes semantic analysis of linguistic content of the signals.

7. The method of claim 1 wherein the signals corresponding to successive communication events represent non-verbal behavioral features.

8. The method of claim 7 wherein processing the signals to generate the plurality of profile indicators includes performing a direct conversion of a speech signal without explicit recognition of words spoken.

9. The method of claim 1 wherein processing the signals generate the profile indicators comprises processing the signals using a first machine-learning component to generate the profile indicators.

10. The method of claim 9 processing the profile indicators to generate a recommendation comprises processing the profile indicators using a second machine-learning component.

11. The method of claim 1 wherein the generating of the recommendation is ongoing during an interaction based on events in the interaction that have occurred.

12. The method of claim 1 wherein the recommendation includes an indicator related to success of a goal for the interaction.

13. A non-transitory machine-readable medium comprising instructions stored thereon, the instructions when executed by a data processing system cause said system to perform steps comprising:
acquiring signals corresponding to successive communication events between multiple parties;
processing the signals to generate a plurality of profile indicators;
processing the profile indicators to generate a recommendation for presenting to at least one of the parties in the interaction; and
presenting the recommendation to the at least one of the parties.

14. A system for aiding a multi-party interaction, the system comprising:
an input for acquiring signals corresponding to successive communication events between multiple parties;
a data processor configured to
process the signals to generate a plurality of profile indicators, and
process the profile indicators to generate a recommendation for presenting to at least one of the parties in the interaction; and
an output for presenting the recommendation to the at least one of the parties.
